(19) United States
(12) Patent Application Publication
(10) Pub. No.: US 2008/0135030 A1
(43) Pub. Date: Jun. 12, 2008

(54) Oil separator insert for a cover of an internal combustion engine

(75) Inventors: Artur Knaus, Hamburg (DE); Wilhelm Seelandt, Rosengarten (DE)

Correspondence Address: VENABLE LLP, P.O. BOX 34385, WASHINGTON, DC, 20043-9998, US

(73) Assignee: Dichtungstechnik G. Bruss GmbH & Co. KG, Hoisdorf (DE)

(21) Appl. No.: 11/984,081

(22) Filed: Nov. 13, 2007

(30) Foreign Application Priority Data
Dec. 8, 2006 (DE) 10 2006 059 114.3

(51) Int. Cl. F02B 25/06

(52) U.S. Cl. 123/572; 123/195 C

(57) ABSTRACT

An oil separator insert for a cover or a housing of an internal combustion engine comprises a stem member and at least one helical surface member arranged along the circumference of said stem member such that a helical channel is formed by said helical surface member. Said helical channel is open towards an outer enveloping surface of said helical surface member. Said insert is provided for being tight-fittingly inserted into a mounting in said cover or said housing, allowing blow-by gases to flow through said helical channel when being tight-fittingly inserted into said mounting. At least an outer part of said helical surface member is made substantially of an elastomer based material.

### CROSS-REFERENCE TO RELATED APPLICATION

This application claims the priority of German Patent Application No. 10 2006 059 114.3, filed on Dec. 8, 2006, the subject matter of which is incorporated herein by reference. Each U.S. and foreign patent and patent application mentioned below is incorporated herein by reference.

### FIELD OF THE INVENTION

The invention relates to an oil separator insert for a cover or a housing of an internal combustion engine, in particular a cylinder head cover.

### BACKGROUND OF THE INVENTION

Oil separators, wherein a coil-shaped insert is arranged in a sleeve, which is then inserted in a suitably worked bore of a cylinder head cover, are known for example from EP 1 199 448 B1, DE 10 2004 011 176 A1, DE 10 2004 011 177 A1 and DE 10 2005 017 328 A1. The construction in form of a cartridge is involved and expensive and requires considerable space.

DE 10 2004 037 157 A1 relates to a separating device composed of two cartridge-like separating elements, wherein the separating elements each have a flow tube with an axially directed gas inlet and outlet at the ends and a helical segment and can be manufactured of one piece for example of an elastomer. The helical segments have a maximum length of half a pitch of the helical segment.

Oil separator inserts for a cylinder head cover according to the preamble of claim 1 are known from DE 101 27 820 A1, DE 197 00 733 C2 and DE 103 21 866 A1. Bypass flows along the wall surface forming the mounting bypassing the helical channel result in a reduced cleaning effect of the oil separator. On the other hand sealing of the plastic inserts with respect to the mounting can only be satisfactorily guaranteed with very close tolerances, which aggravates economical producibility with satisfactory efficiency of the separator. In addition, the mentioned oil separator inserts require separate attachment in the mounting of the cylinder head cover, in the case of DE 197 00 733 C2 for example by means of a screw or snap-on connection, which increases the effort accordingly. The insert according to DE 103 21 866 A1 comprises a volume-changing element of rubber arranged in the helical channel.

### SUMMARY OF THE INVENTION

It is an object of the present invention to provide an oil separator insert with a high degree of cleaning and low manufacturing effort.

The above and other objects are accomplished by the invention, wherein there is provided, according to one embodiment, an oil separator insert for a cover or a housing of an internal combustion engine, comprising a stem member and at least one helical surface member arranged along the circumference of said stem member, such that a helical channel is formed by said helical surface member, said helical channel being open towards an outer enveloping surface of said helical surface member, said insert being provided for being tight-fittingly inserted into a mounting in said cover or said housing, allowing blow-by gases to flow through said helical channel when being tight-fittingly inserted into said mounting, at least an outer part of said helical surface member being made substantially of an elastomer based material, whereby said mounting closes said helical channel at said outward enveloping surface in a sealing manner when said insert is tight-fittingly inserted into said mounting, thereby preventing bypass flow at said enveloping surface.

The tight-fit of the insert in the mounting and the use of elastomer at least on the outer part of the helical surface member, i.e. in the region of the tight-fit, allows sealing between the insert and the mounting in the cover or the housing. In addition, through elastic deformation of the insert on insertion in the mounting a force can be created which counteracts the insert drifting out of the mounting. The insert can then be firmly held in the mounting without additional fasteners.

The helical channel is open towards the outside enveloping surface. To form a closed helical channel the insert is terminated by a circumferential wall which is part of the housing of the cylinder head cover or permanently joined with said cylinder head cover, but not part of the insert or permanently joined with said insert. Therefore the invention is delimited over cartridge-like inserts. The open construction of the helical channel makes possible simple manufacture of a one-piece insert with more than one helical surface member winding.

The insert according to the invention is in particular used as an integrated oil separator in a cylinder head cover through which blow-by gas flows. An application in bores or channels in the cylinder head or engine or crankcase through which blow-by gas flows is also conceivable. The invention is thus delimited over external oil separators not arranged in the engine block.

Preferably the entire insert can be manufactured of an elastomer or thermoplastic elastomer which leads to particularly low manufacturing effort. However, this need not be mandatorily the case. To exercise the sealing and/or locking function it is sufficient if the insert in the region of the interaction or contact with the mounting, i.e. on its outer part, consists of an elastomer or thermoplastic elastomer. In a further preferred embodiment the entire helical surface member consists of an elastomer or thermoplastic elastomer, while the material of the stem member is not subject to any restriction.

### BRIEF DESCRIPTION OF THE DRAWINGS

In the following, the invention is explained by embodiments of the invention, making reference to the accompanying drawings.

FIG. 1 depicts a cross section through a cylinder head cover as cut-out.

FIG. 2 is a perspective view of an oil separator insert for a cylinder head cover.

FIG. 3 depicts a cross section through an oil separator insert for a cylinder head cover with inclined installation position.

FIG. 4 depicts a further embodiment of an oil separator insert in a state pressed into a housing bore.

FIG. 5 is a detailed view from FIG. 4 in the contact region between insert and bore.

FIG. 6 depicts the insert from FIG. 4 in the state prior to the assembly.

FIG. 7 is a detail view from FIG. 6 in the contact region between insert and helix.

FIG. 8 is a half-sectional view of the insert from FIG. 6.

### DETAILED DESCRIPTION

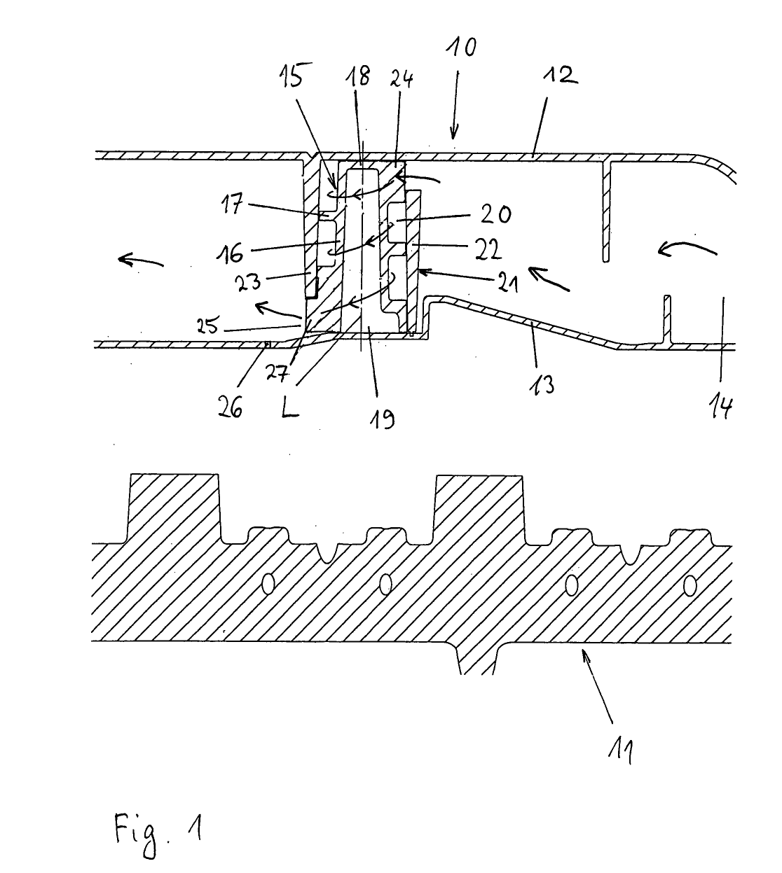

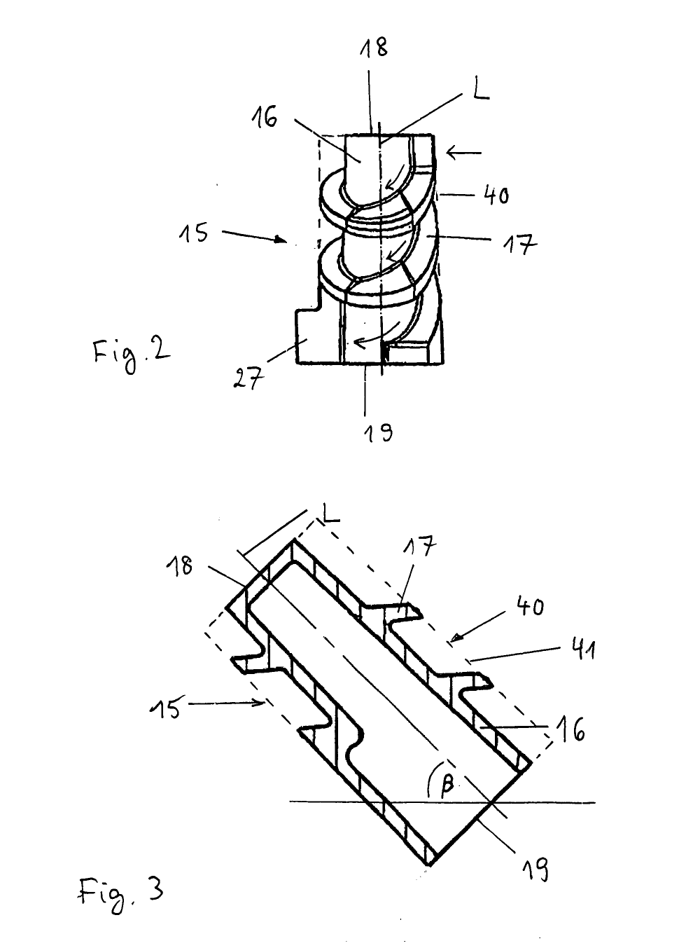

FIG. 1 shows a cut-out of a cylinder head cover 10 for a cylinder head 11. The cylinder head cover 10 comprises an upper housing shell 12 and a lower housing shell 13, which for example can be made of thermoplastic and be joined with each other through welding. Blow-by gases indicated by means of arrows flow through the space formed between the housing shells 12, 13 and which space thus forms a part of the crankcase ventilation. The blow-by gases escaping from the cylinder are directed through bores or channels in the engine or crankcase and the cylinder head to a gas inlet region 14 of the cylinder head cover 10. For cleaning the blow-by gases, more preferably for separating small and minute oil particles contained therein, an oil separator insert 15 is arranged in the cylinder head cover 10, i.e. in the space formed between the housing shells 12, 13. The insert 15 consists of a stem member 16 and a helical surface member arranged on the outside of the stem member 16. In the exemplary embodiments of FIG. 1 to 3 the helical surface member 17 continuously runs from one axial end 18 of the stem member 16 to an opposite axial end 19 of the stem member 16. As a result of this, an axially continuous helical channel 20 is formed. “Axial” refers to a longitudinal axis L of the stem member 16 or the insert 15. The envelope 40 of the insert 15 is substantially cylindrical which includes an advantageous conicity of the envelope 40 and comprises a cylindrical surface 41 and end surfaces 18, 19 as is shown in FIGS. 2 and 3.

With regard to the helical channel, i.e. the space formed between the windings of the helical surface member 17, the insert 15 is radially open in the direction towards the outer cylindrical surface.

For forming a closed helical channel 20 the insert 15 is closed by a circumferential wall 21. Here, the circumferential wall 21 is part of the housing 12, 13 of the cylinder head cover 10 or firmly joined with said cover but not part of the insert 15 or permanently joined with said insert (this delimits the invention over cartridge-like inserts). The circumferential wall 21 can be formed of one or multiple parts. FIG. 1 for example shows a wall portion 23 joined with the housing shell 12 and a wall portion 22 joined with the housing shell 13. The closed helical channel 20 is formed by inserting the insert 15 in the circumferential wall 21 of the cylinder head cover 10.

With the engine in operation, blow-by gas enters the helical channel 20 through the gas inlet opening 24. The gas inlet opening 24 is arranged on one end 18, preferably on the upper end of the insert 15. The gas inlet opening 24 is furthermore arranged so that the inflowing gas enters approximately tangentially with respect to the stem member 16. The gas flows through the entire helical channel 20 to the gas outlet opening 25 arranged on the opposite end 19 of the insert 15. As a result of the helical surface member 17 the gas flow is forced into rotation. The included liquid particles are radially driven outward through the centrifugal force and more preferably because of coalescence (formation of droplets) separated on the circumferential wall 21. The separated oil runs through the helical channel 20 to an oil return aperture 26 in the housing shell 30, through which the oil is returned to the engine oil circuit. Entry of gas that has not been cleaned via the oil return aperture 26 is prevented through means which are not shown. The cleaned air is returned to the intake via the cylinder head cover 10. The oil separator 15 thus is based on the centrifugal effect on the oil particles contained in the blow-by gas due to the helical movement of the blow-by gas in the helical insert 15, so that functionally it is a centrifugal separator.

In the example of FIGS. 1 to 3 the insert 15 is preferentially completely manufactured of an elastomer or rubber. Alternatively the helical surface member 17 can for example be manufactured of elastomer and the stem member 16 of another suitable material. The outer contour of the insert 15 corresponds to the contour of the mounting 21; in particular in case of a mounting 21 which is conical due to a tapered shape, the envelope 40 of the insert 15 is likewise conical in shape as is visible for example from FIG. 1.

The outer part of the helical surface member 17 is inserted in the circumferential wall 21 of the cylinder head cover with tight fit due to a suitable oversize, in particular in the 1/10 mm range, as a result of which the gap between the insert 15 and the circumferential wall 21 is sealed. As a result of this a (in FIG. 1 for example vertical) bypass flow between the insert 15 and the circumferential wall 21, which because of the absence of centrifugal force does not generate any cleaning effect, is prevented or substantially suppressed with simple means.

The complete helical channel 20 from the inlet end 18 to the outlet end 19 has the advantage that axial-parallel flows which do not create any centrifugal force are substantially avoided which increases the cleaning effect.

Because of the gas inlet 24 arranged at the top the insert 15 forms a barrier against oil entering the cylinder head cover and in this way delays flooding of the separator in driving states such as for example full braking.

The insert 15 can have a for example web-shaped protruding member 27 which protrudes over the contour 41 of the helical surface member 17, which protruding member 27 in interaction with a corresponding for example slit-shaped opening in the cylinder head cover 10, here of the wall portion 23, serves for the unambiguous orientation of the insert 15 during the assembly of the cylinder head cover 10.

The oil separator insert 15 according to FIGS. 1 and 2 is adapted for an approximately vertical installation position of the insert in accordance with an approximately horizontally arranged cylinder head cover 10. In contrast to this the oil separator insert 15 according to FIG. 3 is adapted to an inclined installation position of the insert 15 in accordance with an inclined cylinder head cover 10 in which the helical surface members 17 in a cross-sectional view enclose an angle with the longitudinal axis L of the insert 15 which approximately corresponds to the inclination angle β of the insert 15 towards the horizontal, while deviations of up to ±10° or even ±20° are possible. Through this arrangement of the helical surface member 17 in case of an inclined arrangement of the cylinder head cover 10, for example in a V-engine, the formation of oil pockets from which separated oil is unable to drain and which can threaten a secure operation of the separator, is avoided. The inclination in the example of FIG. 3 for example amounts to 45° but the inclination of the helical surface member 17 can also be applied to any other inclinations.

The insert 15 according to FIG. 1 to 3 has one continuous helix 20. In another embodiment a plurality of helices can be provided.

The cylinder head cover 10 can have a plurality of mountings 21 for a corresponding plurality of oil separator inserts 15 which can be connected in parallel and/or in series.

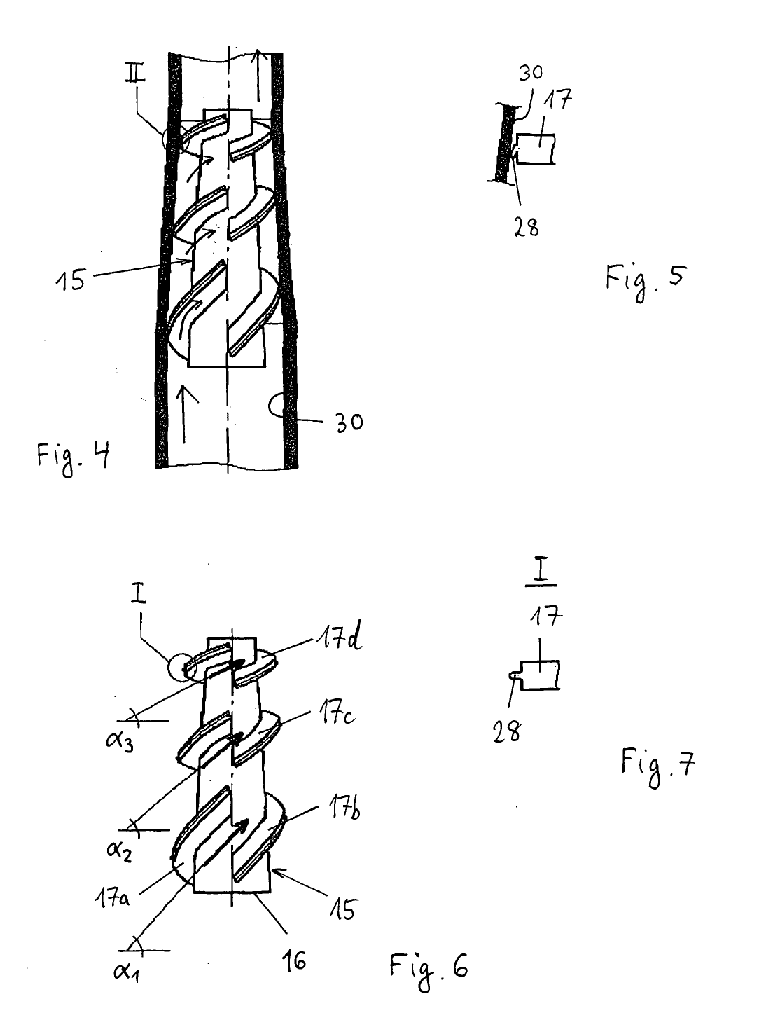

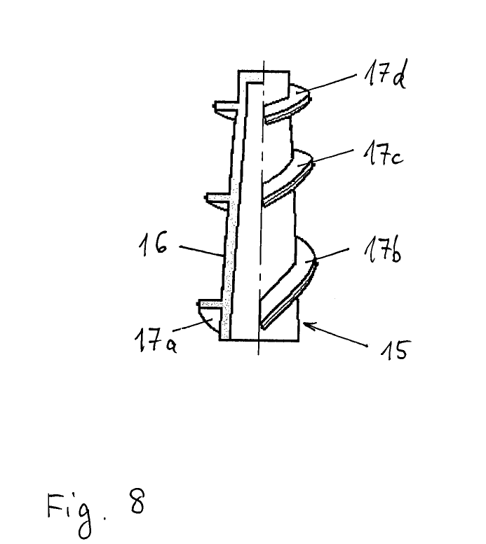

The embodiment according to FIG. 4 to 8 generally relates to an insert 15 inserted or pressed into a channel or a bore 30 of a housing of an internal combustion engine. As is evident from FIGS. 5 and 7 the helical surface member 17 of the insert 15 has an outer tip or outer sealing lip 28 of elastomer, which, because of an appropriate oversize, deforms elastically with insert 15 inserted in the channel or the bore 30 or in the mounting 21 (see FIG. 5) and because of this achieves the desired sealing effect. In addition, because of the elastic deformation of the tip or sealing lip 28, a force which counteracts the insert 15 drifting out of the generally conical bore 30 is created, i.e. the insert 15 blocks or spreads itself against drifting out of the conical bore 30. As a result of this a tight seat of the insert 15 in the bore 30 in the manner of a wall plug is achieved without additional fasteners.

In the embodiment according to FIG. 4 to 8 the insert 15 comprises a plurality of helical surface members formed by sections 17a, 17b, 17c, . . . , which can simplify the manufacture, in particular if the helical surface members consist of flat surfaces.

As is evident from FIG. 6 the helical surface member can have a variable pitch with decreasing angles α1, α2, α3 in flow direction, by means of which compared with a helix with constant pitch, the flow resistance for creating the rotation can be reduced. Through a variable pitch it can also be achieved that with an inclined installation position a continuous incline for the draining of the separated oil is ensured.

The stem member 16 of the insert 15 can be hollow as is shown in FIG. 1 to 3, which for example permits the engagement of an assembly tool, which during the assembly holds the insert in a stable shape. To increase the stability the stem member 16 can be solid. In case of a stem member 16 of elastomer a reinforcing insert for example of wire can be provided.

The insert 15 with a view to the application in an internal combustion engine expediently consists of an adequately temperature-resistant material.

What is claimed is:

1. An oil separator insert for a cover or a housing of an internal combustion engine, comprising:
a stem member; and
at least one helical surface member arranged along the circumference of said stem member, such that a helical channel is formed by said helical surface member, said helical channel being open towards an outer enveloping surface of said helical surface member,
said insert being provided for being tight-fittingly inserted into a mounting in said cover or said housing, allowing blow-by gases to flow through said helical channel when being tight-fittingly inserted into said mounting,
at least an outer part of said helical surface member being made substantially of an elastomer based material,
whereby said mounting closes said helical channel at said outward enveloping surface in a sealing manner when said insert is tight-fittingly inserted into said mounting, thereby preventing bypass flow at said enveloping surface.

2. The insert according to claim 1, wherein said insert has an oversize with respect to said mounting.

3. The insert according to claim 1, wherein said insert is substantially completely made of an elastomer based material.

4. The insert according to claim 1, wherein said insert is substantially completely made of a thermoplastic elastomer.

5. The insert according to claim 1, wherein said helical surface member is continuous.

6. The insert according to claim 1, further comprising a substantially tangential gas inlet.

7. The insert according to claim 1, wherein said insert has a conical contour.

8. The insert according to claim 1, wherein in a longitudinal cross-sectional view said helical surface member is inclined with respect to the longitudinal axis of the stem member.

9. The insert according to claim 1, wherein said helical surface member comprises an outer tip or an outer sealing lip.

10. A cover or housing assembly for an internal combustion engine, comprising:
a cover or housing, said cover or housing comprising a mounting; and
an oil separator insert for being tight-fittingly inserted into said mounting;
said insert comprising:
a stem member; and
at least one helical surface member arranged along the circumference of said stem member, such that a helical channel is formed by said helical surface member, said helical channel being open towards an outer enveloping surface of said helical surface member,
said insert allowing blow-by gases to flow through said helical channel when being tight-fittingly inserted into said mounting,
at least an outer part of said helical surface member being made substantially of an elastomer based material,
whereby said mounting closes said helical channel at said outward enveloping surface in a sealing manner when said insert is tight-fittingly inserted into said mounting, thereby preventing bypass flow at said enveloping surface.

11. The assembly according to claim 10, wherein said insert has an oversize with respect to said mounting.

12. The assembly according to claim 10, wherein said insert is substantially completely made of an elastomer based material.

13. The assembly according to claim 10, wherein said insert is substantially completely made of a thermoplastic elastomer.

14. The assembly according to claim 10, wherein said helical surface member is continuous.

15. The assembly according to claim 10, further comprising a substantially tangential gas inlet.

16. The assembly according to claim 10, wherein said insert has a conical contour.

17. The assembly according to claim 10, wherein in a longitudinal cross-sectional view said helical surface member is inclined with respect to the longitudinal axis of the stem member.

18. The assembly according to claim 10, wherein said helical surface member comprises an outer tip or an outer sealing lip.
